(19) United States
(12) Patent Application Publication
(10) Pub. No.: US 2003/0022677 A1
(43) Pub. Date: Jan. 30, 2003

(54) Transporting data

(76) Inventor: Lauri Piikivi, Oulu (FI)

Correspondence Address: Docket Clerk, P.O. Box 802432, Dallas, TX, 75380, US

(21) Appl. No.: 10/177,967

(22) Filed: Jun. 21, 2002

(30) Foreign Application Priority Data
Jun. 21, 2001 (GB) 0115236.2

(51) Int. Cl. H04Q 7/20

(52) U.S. Cl. 455/466

(57) ABSTRACT

A method for transporting data comprises generation of a data entity in data storage means (14). The data entity is provided with further information. The data entity is then transported from the storage means to an interface means (10) via a first communication media (20). Said further information is studied at the interface means for determining a user equipment (1) to which data shall be transmitted from the interface means. Data is then transported from the interface means to said user equipment based on said information via a second communication media (11).

The present invention relates to transportation of data, and in particular, but not exclusively, to transportation of data between a remote data storage entity and a user equipment.

User equipment such as mobile stations, portable computers, personal data assistants,(PDA) and so on are known. A user equipment may be used for storing and/or processing various kinds of data. For example, without limiting to these, a user may store contact information such as telephone numbers, email addresses or other addresses or other contact information in the storage means of the user equipment. The user may also keep an electronic diary by his/hers user equipment. The user may also store data about various features and/or settings of the user equipment. For example, data such as data associated with different ringing melodies, standard text messages, keyboard and other settings associated with the input/output functions of the user equipment and so on can be stored the user equipment.

The data storage and data processing functions are typically controlled by a controller facility of the user equipment, such as a central processing unit or other data processing entity. The data storage means may comprise non-volatile memory means such as FLASH, ESPROM, external memory cards and so on.

In the prior art the user has to actively look for data he/she may wish to store in the storage means of the user equipment. After having found such data the user has to insert said data into e.g. has mobile phone. Conventionally data has been input manually into the user equipment. More particularly, data has been inserted by means of a manual user interface such as a keyboard of the user equipment.

A communication media can be provided between the user equipment and a data storage means for enabling the user to download data from a remote data storage means. For example, telephone number, email address or diary information may be downloaded to a mobile station from a database via a wireless interface. The information can be retrieved from the database e.g. by means of a WWW or WAP browser function of the mobile station.

The user initiates the download procedure by instructing the user equipment to download data from the remote database. The control instruction are input by the user interface of the user equipment. For example, the user may press appropriate keys of a mobile phone to initiate download of data. The download may be initiated by selecting a graphical link to the wanted data while browsing a phonebook web site.

Instead of downloading new data, the user may wish to update data already stored in the user equipment. Again, the user has to actively seek for the update information and to initiate the download of the update.

Embodiments of the present invention aim to address one or several of the above problems.

According to one aspect of the present invention, there is provided a method of transporting data comprising: generating in data storage means a data entity and providing the data entity with further information; transporting the data entity from the storage means to an interface means via a first communication media; studying said further information at the interface means for determining a user equipment to which data shall be transmitted from the interface means; and transporting data from the interface means to said user equipment based on said information via a second communication media.

According to another aspect of the present invention there is provided an arrangement in a communication system for providing a user equipment with data, comprising: a data storage means connected to a first communication media; interface means connected to the first communication media and provided with means for communication with the user equipment via a second communication media, wherein the interface means comprises means for determining based on further information provided in a data entity received from the data storage means if data shall be transmitted to the user equipment.

According to another aspect of the present invention there is provided a data entity for transporting data from a data storage means connected to a data communication system to a user equipment, said data entity including said data and further information based on which an interface terminal means connected to the data communication system and receiving said data entity is enabled to communicate said data to the user equipment via a local communication media.

According to still another aspect of the present invention there is provided a terminal connected to a data communication system, comprising: means for receiving data entity from a data storage means via the data communication system; means for detecting that data that is included in the data entity is to be forwarded to a user equipment based on further information also included in said data entity; and means for communicating said data to the user equipment via a local communication media.

In a more specific form of the invention the data entity is generated in a service provider entity connected to a data communication system. The data may be provided by means of a web site maintained by the service provider entity. The interface means may comprise a user terminal connected to the data communication system.

The second communication media may comprise a local communication link. The local link may comprise a short range wireless link.

Said information provided in association with the data entity may comprise information about the content of the data entity. The information may comprise content type. Said information may also comprise address information associated with the user equipment.

The procedure of transmitting data to the user equipment may be initiated automatically in response to detection that the interface means has data to be transmitted to the user equipment. The user equipment may also initiate the procedure of transmitting data to the user equipment.

The user of the user equipment may input new data or modify existing data by means of the interface means. The interface means may also change the format of data before transmission thereof to the user equipment.

Executable program code may also be transmitted to the user equipment.

A connection establishment procedure may be initiated at the user equipment in response to receiving data from the interface means.

The embodiments of the invention may provide an improved approach for downloading new data into a user equipment and/or updating data already stored in a user equipment. The embodiments may make the usage of mobile user equipment easier. The user may not need to actively seek for data and/or initiate any download operations. The embodiments may enable easy interoperability with existing data network services.

For better understanding of the present invention, reference will now be made by way of example to the accompanying drawings in which:

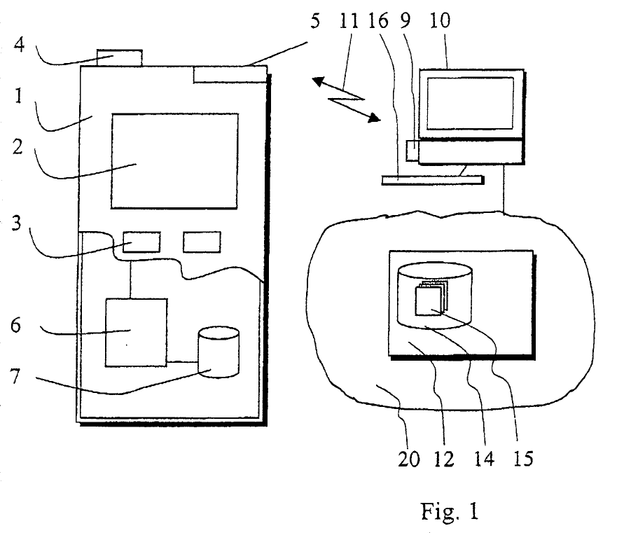

FIG. 1 shows one embodiment of the present invention; and

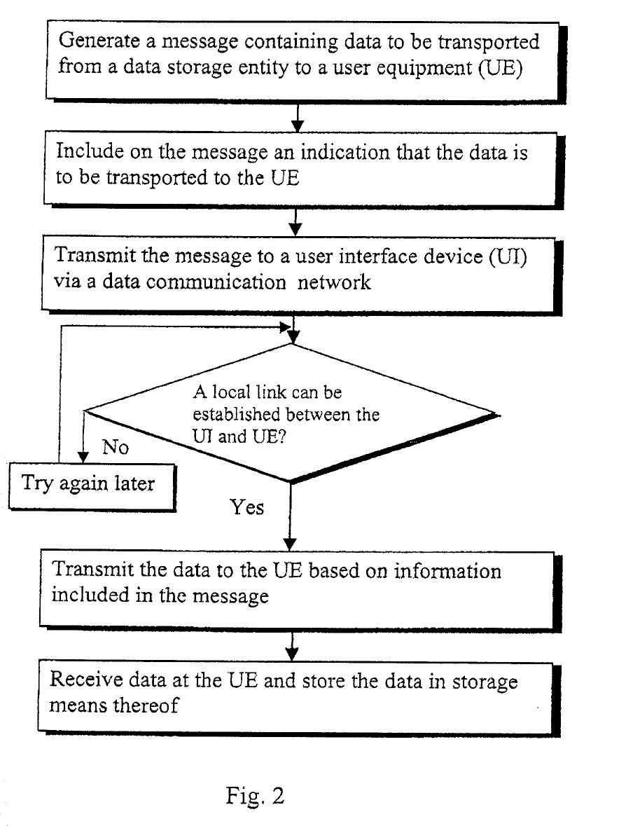

FIG. 2 is a flowchart illustrating the operation of an embodiment of the present invention.

Reference is first made to FIG. 1 showing a schematic presentation of a user equipment 1 that is adapted to receive data from a remote data storage means. The remote data storage means are shown to comprise a database 14 provided by a service provider entity 12. A computer terminal 10 connected to a data network 20 is also shown. More particularly, in FIG. 1 a web user interface is provided by means of a personal computer (PC).

The data network may be any data communication media adapted for communication of data between the computer terminal 10 and other entities connected to the data network. In the embodiment described in the following it is assumed that the data network is adapted for communication in accordance with communication protocols that are used in the World Wide Web (WWW). These protocols include transfer protocols such as the HTTP (Hyper Text Transfer Protocol).

More particularly, the user equipment of FIG. 1 comprises a mobile station 1 that may be used for communication over a wireless interface. If the mobile station 1 subscribes to a cellular mobile communication network the mobile station 1 is adapted to communicate with a transceiver entity of the mobile communication network.

Various possible transceivers entities that may be in communication with the mobile station 1 are known. These are not illustrated or described in any greater detail as they do not form an essential element of the invention. It is sufficient to note that a transceiver entity may comprise a base station (STS) of a cellular system or any other appropriate element with which the mobile station 1 may communicate with over a wireless interface. Other elements of a cellular communication system are also known by the skilled person and are omitted from FIG. 1 for clarity reasons.

The mobile station 1 may be provided with user interface means comprising a display 2 and input means. The skilled person is familiar with different user interfaces of a mobile station and therefore these will not be described in more detail herein. It is sufficient to note that the input means may be formed by control buttons 3 or they may include e.g. voice activation or touch screen means and so on.

The mobile station 1 may also be provided with communication interface means such as antenna means for communication with the transceiver entity of the communication system the mobile station subscribes to. The antenna means may comprise an external antenna element 4, or then built-in or integrated antenna means may be used.

The partially sectioned mobile station 1 is shown to comprise a processor entity 6 and a data storage means 7. The processor entity 6 is adapted to process data and/or control reception and/or transmission of data from and/or to the mobile station. The processor function 6 may be integrated with at least one other processor function of the mobile station 1 or may be adapted to process data that associates e.g. with calendar functions only.

The data storage means are for storing data received from a remote data storage entity, such as the database 14. The data storage means 7 may be either integrated with at least one other storage function of the mobile station 1 or be assignee solely for storage of specific data.

Separation of one or more of the data processing and/or data storage functions of the mobile station from other functions of the mobile station 1 may be preferred e.g. for security or usability reasons.

FIG. 1 shows a remote entity 12 that will be referred to as ‘service provider’. The service provider entity 12 is adapted to provide the user equipment with data or data update. The service provider shall be understood to be any party that may store and/or provide data for the mobile station 1. In a practical implementation the service provider 12 may comprise a server that is adapted for provision of commercial or non-commercial services for the user of the mobile station 1. The data can be stored in storage means such as database 14 of the service provider entity 12.

In a more specific embodiment the data storage means is adapted to enable the service provider to create a web site 15. The web site may comprise a collection of web pages. The skilled person is familiar with the basic concept of a web site and it is thus not explained in any great detail. It is sufficient to note that a web site may be, for example, based on the Wireless Application Protocol (WAP) or protocols used in the World Wide Web (WWW) and that the site may be implemented based on an appropriate markup language. Examples of the markup languages include, without limiting to these, WML (wireless markup language), HTML (hypertext markup language), and XHTML (extended hypertex: markup language).

A user interface means such as the computer terminal 10 may be used for downloading data from the server 12 and more particularly from the web site 15 stored in the server. For example, contact information may be fetched from the server 12. The contact information may comprise e.g. a company phonebook. Personal Calendar programs and so on can also be downloaded from the database. It shall be appreciated that the data stored in the server may also comprise any other data such as data associated with services provided by the operator of the communication network.

In addition to the user requesting for data, the service provider 12 may push data towards the user via the computer terminal 10. For example, the service provider entity 12 may sent data to the user by sending an email or a short message service (SMS) message to the computer terminal 10.

The data from the server 12 may be forwarded from the user interface means 10 to the mobile station 1 via an appropriate communication media. In FIG. 1 embodiment the communication media is based on a low power local radio link 11 provided between the computer terminal 10 and the mobile station 1. The data from the user interface unit 10 may be new data or an update of data already stored in the memory means 7 of the mobile station 1.

The low power radio link 11 may be based on any appropriate short range radio link technologies. An example of the short range radio links is the Bluetooth™. The Bluetooth™ enables short range, local wireless access between Bluetooth™ enabled devices. Bluetooth™ refers to a technology specification by Bluetooth™ special interest group (SAG) for small factor, low-cost, short range radio links (SRRL) between various devices provided with Bluetooth™ wireless modules. The Bluetooth™ protocol specifies also call establishment and personal data (such as business card, calendar event) formats for the Bluetooth™ enabled devices, such as the mobile station 1 of FIG. 1.

A first device equipped with a Bluetooth™ module may establish an instant connection with another device provided with a Bluetooth™ module as soon as the other wireless module comes within the range of the first device. The Bluetooth™ technology allows for a replacement of many proprietary cables that conventionally have connected portable and/or stationary devices to each other with a universal short range radio link. The connection may be established and maintained even when the devices are not within line of sight. The range of each radio service area can be, for example about 10 meters, but the range can be extended to around 100 meters, e.g. by use of an appropriate amplifier.

The Bluetooth™ specification defines a fast acknowledgement and frequency hopping scheme to improve the robustness of the wireless link and to combat interference and fading. Bluetooth™ wireless modules avoid interference from other signals by hopping to a new frequency after transmitting or receiving a data packet. The use of short data packets and fast hopping is also advantageous since it may limit the impact of other devices such as microwave ovens or TVs.

As shown in FIG. 1 the mobile station 1 and the computer terminal 10 are each provided with a Bluetooth™ module 5 and 9, respectively. The module nay be a chip that comprises a processor, a radio part and other means requited for establishment of communication media between the two modules.

The data transmission arrangement between the computer terminal 10 and the mobile station 1 may be such that the wireless module 9 of the computer 10 monitors continuously if a mobile station with a co-operational wireless module has entered the short range radio link service area of the wireless module 9. After a mobile station 1 with a cooperative module 5 has entered a Bluetooth™ ‘piconet’ of the module 9, and upon detection of the mobile station 1, a data communication media may be established between the modules. The detection may be based on the Bluetooth™ broadcasting and detection protocols.

It should be appreciated that the detection of an existing other co-operative short range radio device may also be accomplished by the mobile station 1. In accordance with one alternative it may be either of the modules 5 and 10 which sends the initial request, depending on which one of the devices detects the other device first.

The computer terminal 10 may be provided with information based on which the terminal can determine the user equipment to which the data shall be transmitted. A possibility for this will now be described in more detail referring also to the flowchart of FIG. 2. The exemplifying embodiment relates to provision of an update of contact information in the storage means 7 of the mobile station 1.

A data entity such as an email message containing data to be transported to the mobile station may be based on Hyper Text Transfer Protocol (HTTP). When generating the data entity the header field of the HTTP (Hyper Text Transfer Protocol) message and MIME (Multipurpose Internet Mail Extension) type of the message can be formed such that the message may be automatically routed from the computer terminal 10 to the mobile station 1 without any intervention by the user of the mobile station 1. The MIME can be used to inform the computer terminal 10 about the content type of the message. The computer may then study the information and based on the content type indication determine that the data content of the message shall be forwarded to the mobile station 1.

The computer 10 receives the message from the server entity 12. In response to indication that the message contains data to be transported to a specific user equipment it may initiate a procedure for looking for said user equipment. This may be based e.g. on the Bluetooth™ detection feature described above. That is, after detection by the computer 10 that data needs to be communicated to a specific mobile station and that a communication link can be established between the computer and the specific mobile station (as indicated by information attached to the message received from the server 12) the computer transmits the data via the local link 11.

To implement the data forwarding operation the computer terminal 10 may be provided with a web browser function. The browser may be adapted to support a plug-in or helper application. This can be provided by means of a software that is adapted to handle certain types of web content. The type of the content can be identified by the MIME types. This content type may be attached to the message when the web page is downloaded from the server 12. Thus, when one of the pages 15 is downloaded the browser function of the computer detects the MIME type and starts the registered plug-in functionality to handle the data. This plug-in will then activate the Bluetooth™ function of the computer terminal 10 for provision of connection to the Bluetooth™ enabled mobile station 1 of the user.

To give a more practical example, MIME types for messages to be transmitted over a Bluetooth™ (BT) link could be defined in the following manner:

Content-type:

application/Bluetooth-device-access

//HTTP header for browser plug-in type

BT-CallEstablish-Number: +NNNNNNNNNN

// start call establishment, phone beep //to notify user

BT-PhoneBookEdit-Name: NN NN //Add name to phonebook

BT-PhoneBookEdit-Number: +NNNNNNNN

The computer terminal may continuously try to locate the user equipment. The computer terminal 10 may also be provided with e.g. a timer arrangement that is initiated after a failed attempt so that a new attempt will be made e.g. after an half an hour or so.

Inclusion of the indication of the target user equipment by the service provider entity 12 enables e.g. automatic update of data stored in the mobile station 1 based on data stored in the remote data storage means 14 of the service provider entity 12.

According to a possibility the user or alternatively the user equipment may enquire from the computer if the computer terminal 10 has any data to be transported to the user equipment. The enquiry or a request to transmit any new data may be made by sending an enquiry message from the user equipment via the local communication media 11 to the computer terminal. The user may also input such an enquiry or request directly to the computer terminal e.g. by means of user interface of he computer such as the keyboard 16 or mouse.

The user may also input calendar events or other data to be transported to the user equipment 1 by using the keyboard 16 of the web user interface 10. Such data may be stored in the computer or alternatively in the storage means 14 of the service provider 14. The data may then be transmitted to the user equipment as explained above. An advantage of using the user interface means of a computer terminal is that the users may find such interface easier to use than the typically small and limited user interface of a portable user equipment.

In an embodiment a connection can be established automatically between the user equipment 1 and another terminal (not shown in FIG. 1) by selecting a web phonebook entry for said other terminal by means of the computer terminal 10. For example, a user may request for a telephone number from a web site phone book by a computer. The telephone number is transported from the web site to the computer via data network and subsequently forwarded to the mobile station of the user via a local interface. The mobile station may then initiate automatically a call establishment procedure for a call to said number. The call establishment may be triggered e.g. by an appropriate indication in the telephone number data, The mobile station is adapted to call to the number in response to detection of said indication.

The radio link 11 between the modules 9 and 5 may require authentication so that the data update is only done if the user and owner of the mobile station are the same person. This can be implemented by the PC terminal 10 e.g. based on the Bluetooth™ address of the mobile station. Authentication data may be asked from the mobile station and compared to user information stored in the computer terminal 10. For example, user name may be configured in the mobile station and compared to the user logged in at the computer terminal. The user may be notified e.g. by a ringing tone of the connection establishment procedures.

It is noted that although in the above data was described as being stored in the storage means of the user equipment after receipt thereof this is not always necessary. A user may not always want to store the fetched information but just use it. Therefore, instead of storing the data at the user equipment 1 it may e.g. be displayed of the display 2 or otherwise presented to the user. For example, a user may browse a phonebook to find an address (e.g. a telephone number) for a person the user does not call that often (or is likely to never call again) and thus there appears to be no need to store the address data in the user equipment 1. In the prior art the user needs to read the number from the display of the computer 10 and then dial the number on his/hers mobile station. The user may wish that even in such case the address information is sent to the user equipment 1 where after the user may choose whether to call directly to the number or store the data in the memory means of the mobile station. A message can be displayed asking the user to select whether the number is stored or used immediately. The selection may be accomplished by means of the input means of the user equipment.

The computer terminal does not necessarily need to known what the content is. The actual data content may be passed transparently via the computer terminal such that it is not possible for any other parties having access to the computer to obtain information about the data content by means of the computer terminal. This may be desired e.g. for security and/or privacy reasons.

The interface means may also be adapted to tailor data content received from the service provider to be more suitable for processing and/or storage by the user equipment. The data processing unit of the computer terminal 10 may be adapted to detect the format of data coming from the service provider and to make the required format changes.

A data content in a message may be transmitted to a number of user equipment. For example, a data update may be transmitted to all mobile stations belonging to a certain user group (e.g. all mobile stations of a company).

The MIME or similar indicator may also be included in an attachment of a message. That is, the service provider may sent a message containing at least one attachment, said attachment being provided with an indication that it shall be transmitted to a specific mobile station or several mobile stations. A message from the service provider entity may comprise a plurality of attachments, each of the attachments being addressed to different users.

The above describes communication of static data to the user equipment. The data may also comprise executable program code. For example, executable data applets such as Java applets may be transported to the user equipment. A simple set of executable instructions can be configured and attached to data communicated to the user equipment. For example, an applet may be attached to a telephone number data stored in a web-phonebook. When a call is established based on data communicated from the phonebook the applet may then e.g. propose to remind the user to call again e.g. after 30 minutes if the call cannot be established and so on.

It shall also be appreciated that whilst embodiments of the present invention have been described in relation to mobile stations embodiments of the present invention are applicable to any other suitable type of user equipment. Furthermore, instead of user interface means that are in the for of a computer terminal the user interface means may comprise any other terminal device capable of communicating with a data storage means via a communication media. For example, the user interface means comprise a digital TV, a cable TV control unit and so on.

The short range interface between the computer interfacing the data network and the user equipment may also be based on other technologies than the Bluetooth™. For example, other local wireless links such as those used by the so called contactless cards or proximity cards could be used for said interface. An example of a short range link for proximity cards is defined by the International Standardisation Organisation (ISO) specification No. ISO 14443. Infrared links may also be used. A possible infrared link is based on the IrDA protocol. The IrDA is a standard defined by Infrared Data Association. Data may also be transferred from the interface means to the user equipment via a cable.

The mobile station 1 may also be adapted to facilitate use thereof for electronic transactions. For example, the user of the mobile station 1 may pay for various goods and/or services by means of the mobile station 1 or access various banking services by the mobile station 1, The mobile station 1 may also be used for ordering, negotiating or purchasing goods and/or services, for receiving a receipt of a purchase, electronic tickets and so on, Further examples of the possibilities include use of the mobile station 1 for transactions that associate with betting, insurance, banking or other financial services. That is, the herein disclosed solution can be used for any other data communication operation where data needs to be sent to a user from a remote party.

It is also noted herein that while the above describes exemplifying embodiments of the invention, there are several variations and modifications which may be made to the disclosed solution without departing from the scope of the present invention as defined in the appended claims.

What is claimed is:

1. A method of transporting data comprising:
generating in data storage means a data entity and providing the data entity with further information;
transporting the data entity from the storage means to an interface means via a first communication media;
studying said further information at the interface means for determining a user equipment to which data shall be transmitted from the interface means; and
transporting data from the interface means to said user equipment based on said information via a second communication media.

2. A method as claimed in claim 1, wherein the data entity is generated in a service provider entity connected to data communication system providing the first communication media.

3. A method as claimed in claim 2, wherein the interface means comprises a user terminal connected to the data communication system.

4. A method as claimed in claim 1, wherein the second communication media comprises a local wireless link.

5. A method as claimed in claim 4, wherein the local wireless link comprises a short range radio link.

6. A method as claimed in claim 5, wherein the short range radio link is based on a radio link protocol defined by a Bluetooth™ special interest group (SIG).

7. A method as claimed in claim 4, wherein the local wireless link comprises an infrared link.

8. A method as claimed in claim 1, wherein the second communication media comprises wiring between the user equipment and the interface means.

9. A method as claimed in claim 1, wherein said information comprises information about the content of the data entity.

10. A method as claimed in claim 9, wherein the information comprises content type.

11. A method as claimed in claim 1, wherein said information comprises address information associated with the user equipment.

12. A method as claimed in claim 1, wherein data is transmitted to the user equipment based on information in a Multipurpose Internet Mail Extension (MIME) of the data entity.

13. A method as claimed in claim 1, wherein the procedure of transmitting data to the user equipment is initiated automatically in response to detection that the interface means has data to be transmitted to the user equipment.

14. A method as claimed in claim 1, wherein the user of the user equipment initiates the procedure of transmitting to the user equipment.

15. A method as claimed in claim 1, comprising detecting that a data communication link can be established between the user equipment and the interface means.

16. A method as claimed in claim 1, wherein the user of the user equipment inputs new data or modifies existing data by means of the interface means.

17. A method as claimed in claim 1, comprising authentication of the user of the user equipment.

18. A method as claimed in claim 1, wherein the user equipment comprises a mobile station.

19. A method as claimed in 2, wherein the data is provided by means of a web site that is maintained by the service provider entity.

20. A method as claimed in 1, wherein the interface means changes the format of data before the data is transmitted to the user equipment.

21. A method as claimed in claim 1, comprising transmission of executable program code to the user equipment.

22. A method as claimed in 1, comprising a step of initiating connection establishment procedure at the user equipment in response to receiving said data from the interface means.

23. An arrangement in a communication system for providing a user equipment with data, comprising:
a data storage means connected to a first communication media;
interface means connected to the first communication media and provided with means for communication with the user equipment via a second communication media,
wherein the interface means comprises means for determining based on further information provided in a data entity received from the data storage means if data shall be transmitted to the user equipment.

24. An arrangement as claimed in claim 23, wherein the data storage means is provided by a service provider entity connected to a data communication system providing the first communication media, the interface means comprises a user terminal, and the second communication media comprises a local communication link.

25. An arrangement as claimed in claim 23, wherein said information comprises information about the content of the data entity.

26. An arrangement as claimed in claim 25, wherein the information comprises content type.

27. An arrangement as claimed in claim 23, wherein said information comprises address information associated with the user equipment.

28. A data entity for transporting data from a data storage means connected to a data communication system to a user equipment, said data entity including said data and further information based on which an interface terminal means connected to the data communication system and receiving said data entity is enabled to communicate said data to the user equipment via a local communication media.

29. A terminal connected to a data communication system, comprising:
means for receiving data entity from a data storage means via the data communication system;
means for detecting that data that is included in the data entity is to be forwarded to a user equipment based on further information also included in said data entity; and
means for communicating said data to the user equipment via a local communication media.
